(19) United States
(12) Patent Application Publication
(10) Pub. No.: US 2020/0042955 A1
(43) Pub. Date: Feb. 6, 2020

(54) ELECTRONIC CHECK GENERATION AND TRANSMISSION SYSTEM

(71) Applicant: Matt Widdows, Scottsdale, AZ (US)

(72) Inventor: Matt Widdows, Scottsdale, AZ (US)

(21) Appl. No.: 16/519,147

(22) Filed: Jul. 23, 2019

Related U.S. Application Data
(60) Provisional application No. 62/714,542, filed on Aug. 3, 2018.

(51) Int. Cl. G06Q 20/04; G06Q 20/42

(52) U.S. Cl. CPC G06Q 20/0425; G06Q 20/42

(57) ABSTRACT

A computer-based electronic check processing system may enable the transmission of electronic checks from a payor system to a payee system. The check processing system may receive a check generation request from the payor system. The check processing system may generate an electronic check based on the check generation request. The check processing system may transmit a check notification to the payee system to notify the payee system that the electronic check was generated. The payee system may access the check processing system, based on the check notification, to interact with and retrieve the electronic check.

### CROSS-REFERENCE TO RELATED APPLICATIONS

This Non-Provisional patent application claims priority to U.S. Provisional Patent Application Ser. No. 62/714,542, entitled “Electronic Check Generation Transmission System,” and filed on Aug. 3, 2018, which is incorporated herein by reference in its entirety for all purposes.

### FIELD

The disclosure relates generally to a check processing system for generating and transmitting electronic checks.

### BACKGROUND

Businesses, individuals, or other entities (e.g., “payors”) may desire to remit payment to various payees in the form of a check. Physical checks may be created by handwriting, typing, or printing the necessary check information. The physical checks may then be physically delivered to the payee using mail, hand delivery, or the like. Electronic checks may also be used to remit payment to a payee. For example, the electronic check may be generated by the payor and electronically transmitted to the payee. In response to the payee depositing the electronic check with the payee's bank, the payee's bank may contact a third-party to validate the check. Typically, the payee's bank may issue a hold on the funds to ensure that the check validates, thus delaying the payment process and the ability of the payee to access the funds. Moreover, a technical problem is that the electronic transmission of checks may be unsecure and susceptible to various security risks, such as man in the middle attacks, fraudulent use of bank account numbers, or the like.

### SUMMARY

Systems, methods, and articles of manufacture (collectively, “the system”) for generating, transmitting, and processing electronic checks are disclosed herein. The system may receive a check generation request from a payor system. The system may transmit a payee check notification to a payee system, wherein in response to receiving the payee check notification the payee system is configured to interact with the check processing system. The system may generate an electronic check based on the check generation request. The system may receive a check redemption request from the payee system, the check redemption request comprising a physical redemption selection, an electronic redemption selection, or a check rejection.

In various embodiments, the check generation request may comprise at least one of payor data, payee data, a check number, a date, a payment amount, an extended payment amount, a memo, or a transmission channel. The transmission channel may comprise a physical distribution, batch processing, an email, a text message, a push notification, or a direct upload to a financial institution. The payee check notification may be transmitted based on the transmission channel specified in the check generation request. The payee check notification may comprise at least one of payor data, payee data, the payment amount, and an access hyperlink, wherein the check notification does not comprise the electronic check. The payee system may be configured to interact with the check processing system by accessing the access hyperlink.

In various embodiments, the system may transmit check data to a financial institution, wherein the check data corresponds to the check generation request. The system may receive a check redemption request from the financial institution in response to the financial institution processing the electronic check from the payee system. The financial institution may be configured to process the electronic check by comparing the check data to the electronic check.

In various embodiments, the system may sync at least one of the check generation request or the electronic check with a payor accounting platform. The payor accounting platform may comprise Intuit QuickBooks®.

In various embodiments, the system may authenticate the payor system. The system may authenticate the payor system by receiving a user credential from the payor system, and validating the user credential. The system may authenticate the payor system by transmitting an authentication challenge, and receiving an authentication response from the payor system based on the authentication challenge.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosures, however, may best be obtained by referring to the detailed description and claims when considered in connection with the drawing figures, wherein like numerals denote like elements.

FIG. 1 is a block diagram illustrating various components of a system for processing electronic checks, in accordance with various embodiments;

FIG. 2 is a block diagram illustrating an exemplary check processing system for use in the system for processing electronic checks of FIG. 1;

FIG. 3 illustrates an exemplary payor user interface (UI) for use in the system for processing electronic checks of FIG. 1, in accordance with various embodiments; and

FIG. 4 illustrates a process flow for a method of processing an electronic check generation request, in accordance with various embodiments.

### DETAILED DESCRIPTION

The detailed description of exemplary embodiments herein makes reference to the accompanying drawings, which show exemplary embodiments by way of illustration and their best mode. While these exemplary embodiments are described in sufficient detail to enable those skilled in the art to practice the disclosures, it should be understood that other embodiments may be realized and that logical, electronic, and mechanical changes may be made without departing from the spirit and scope of the disclosures. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Any reference to without contact (or similar phrases) may also include reduced contact or minimal contact. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used herein, “each” refers to each member of a set or each member of a subset of a set. Furthermore, any reference to singular includes plural embodiments, and any reference to more than one component may include a singular embodiment. Although specific advantages have been enumerated herein, various embodiments may include some, none, or all of the enumerated advantages.

In various embodiments, systems, methods, and articles of manufacture (collectively, the “system”) for generating and processing electronic checks are disclosed. The system may enable a payor (e.g., a user, an entity, a payor system, etc.) to generate one or more electronic checks. For example, the payor may access the system and input the payor's transaction account, a designated payee's data, and the like to generate the electronic check. The payor may print the electronic check (e.g., to mail to the payee), upload the electronic check directly to a financial institution, save the electronic check for batch processing, electronically notify the payee of the electronic check (e.g., by transmitting a check notification to the payee), or the like. In response to the system transmitting the check notification to the payee, the payee may access the system to view the electronic check, print the electronic check, upload the electronic check directly to the payee's financial institution, save or download an image of the electronic check, or the like. In various embodiments, and in contrast to typical money transfer systems such as wiring cash, the system may require less personal information about the payee to complete the electronic check transfer process (e.g., the system does not require payee account information, bank information, etc.).

The system further improves the functioning of the computer. For example, by transmitting, storing, and accessing electronic checks, payor data, payee data, and the like using the processes described herein, the security of the data is improved, which decreases the risk of the computer or network from being compromised. As an example, by transmitting only a check notification to the payee in response to the payor generating an electronic check, confidential data corresponding to transaction accounts is not transmitted over possibly unsecure channels, thus improving the security of confidential data. In various embodiments, the system may also enable the payee to cash or deposit the electronic check immediately, without needing the financial system to place a hold on the funds until the electronic check can be validated.

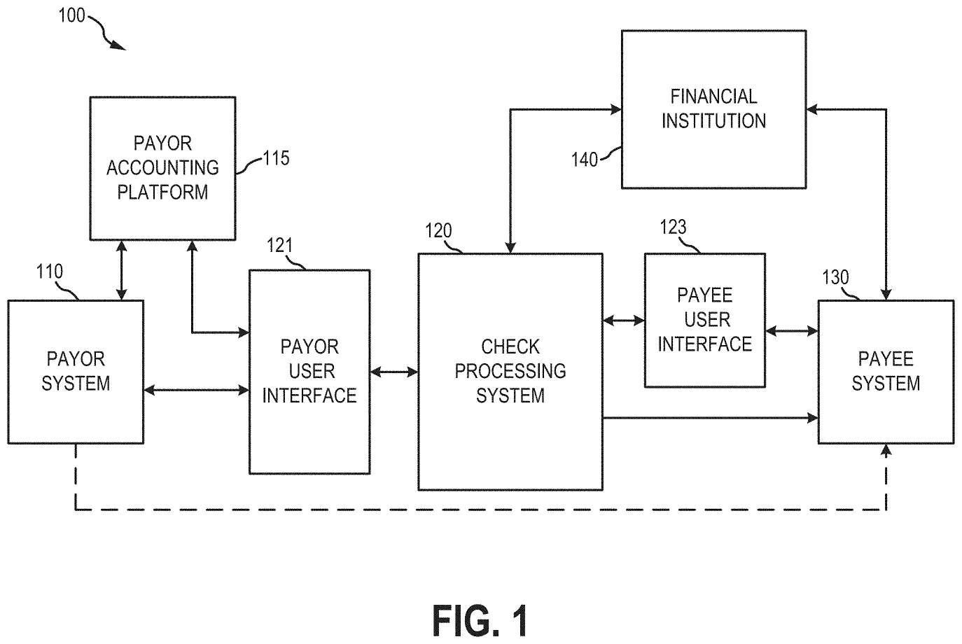

Referring now to FIG. 1, a system 100 for generating and processing electronic checks is shown, in accordance with various embodiments. System 100 may include one or more of a payor system 110, a check processing system 120, a payee system 130, and/or a financial institution 140. System 100 may also contemplate uses in association with web services, utility computing, pervasive and individualized computing, security and identity solutions, autonomic computing, cloud computing, mobility and wireless solutions, open source, biometrics, grid computing, and/or mesh computing.

The various system 100 components may be independently, separately, or collectively electronically coupled to each other, or in electronic communication, via one or more networks. The networks may be any suitable electronic link capable of carrying communication between two or more systems, such as payor system 110 and check processing system 120, payee system 130 and check processing system 120, check processing system 120 and financial institution 140, and/or payee system 130 and financial institution 140. For example, one or more networks may be a local area network (LAN) using TCP/IP communication or a wide area network (WAN) communicating at least in part over the Internet. One or more networks may also be an internal network isolated from the Internet in various embodiments for enhanced security. A network may be unsecure. Thus, communication over the network may utilize data encryption. Encryption may be performed by way of any of the techniques now available in the art or which may become available (e.g., Twofish, RSA, El Gamal, Schorr signature, AES, SHA, DSA, PGP, PKI, GPG (GnuPG), HPE Format-Preserving Encryption (FPE), Voltage, symmetric and asymmetric cryptosystems, etc.).

For the sake of brevity, conventional data networking, application development, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In various embodiments, payor system 110 may be configured to interact with check processing system 120 to generate and transmit electronic checks, as discussed further herein. Payor system 110 may comprise any suitable hardware, software, and/or database components capable of transmitting, receiving, and storing data. For example, payor system 110 may comprise one or more servers, computers, laptops, tablets, cellular phones, smartphones (e.g., IPHONE®, BLACKBERRY®, and/or the like), Internet of Things (IoT) devices, and/or the like. Payor system 110 may comprise an operating system, such as, for example, a WINDOWS® mobile operating system, an ANDROID® operating system, APPLE® IOS®, a BLACKBERRY® operating system, a LINUX operating system, and the like. Payor system 110 may also comprise software components configured to allow the payor, via payor system 110, access to payor user interface (UI) 121. For example, payor system 110 may include a web browser (e.g., MICROSOFT INTERNET EXPLORER®, GOOGLE CHROME®, etc.), an application, a micro-app or mobile application, or the like, configured to allow the payor to access and interact with payor UI 121.

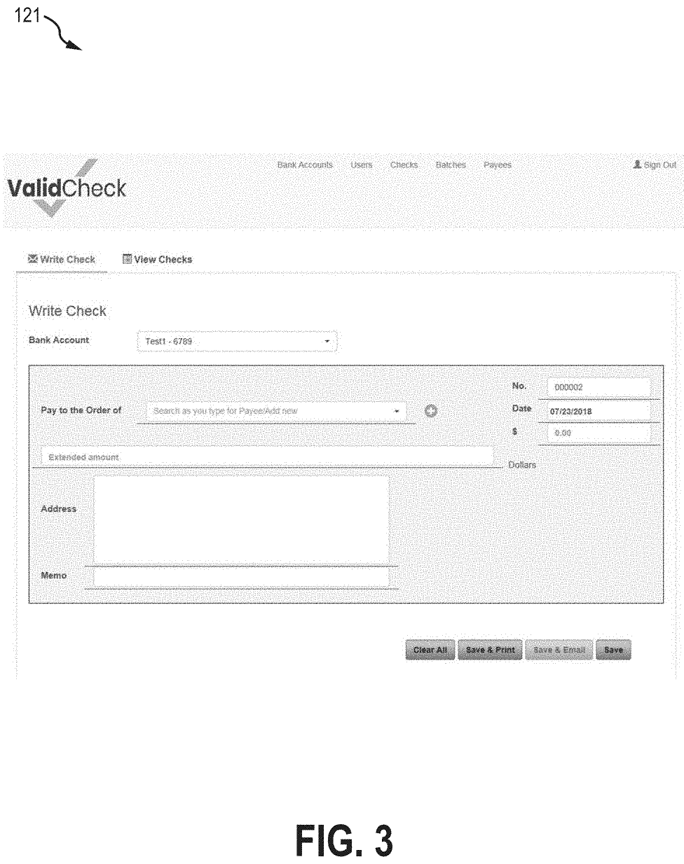

In various embodiments, payor system 110 may be in electronic communication with payor UI 121. With reference to FIGS. 1 and 3, payor UI 121 may comprise software, a mobile application, a web interface, or the like accessible from payor system 110. For example, payor UI 121 may include a graphical user interface (“GUI”), software modules, logic engines, various databases, interfaces to systems and tools, and/or computer networks. Payor UI 121 may allow the payor, via payor system 110, to input payor data and payee data, initiate one or more check generation requests, and the like. Payor UI 121 may also enable the payor to input, edit, or remove one or more transaction accounts; input, edit, or remove one or more authorized payors (e.g., additional authorized users); review previously generated electronic checks and data regarding the generated electronic checks (e.g., electronic check status, etc.); review and execute batch electronic check transmissions; input, edit, or remove one or more authorized payees; and/or the like. The payor may access payor UI 121 by inputting user credentials (e.g., a username, password, biometric input, etc.), and may view data regarding the sender's transaction accounts, including, for example, account balances, account transactions, or the like.). In various embodiments, payor UI 121 may be in electronic and/or operative communication with check processing system 120. In various embodiments, payor UI 121 may be hosted on check processing system 120 (e.g., via a web server, or the like) and accessible via payor system 110.

In various embodiments, payor UI 121 may also integrate with a payor accounting platform 115. Payor accounting platform 115 may comprise accounting software, financial software, enterprise resource planning (ERP) system, or the like, corresponding to one or more payor systems 110. For example, an exemplary payor accounting platform 115 may comprise FRESHBOOKS®, INTUIT QUICKBOOKS®, WAVE™, XERO™, ZOHO BOOKS®, or the like. Payor system 110 may be configured to interact with payor accounting platform to update and track various financial metrics, including, for example, accounts payable, accounts due, balance sheets, incoming statements, and/or any other desired financial data. In various embodiments, check processing system 120, via payor UI 121, may be configured to interact with payor accounting platform 115. In that regard, payor UI 121 may update data in payor accounting platform 115 based on the check generation request, the electronic checks generated by the payor (e.g., to debit the respective payor account), the selected payee (e.g., to establish record of the payment), or the like.

In various embodiments, payor UI 121 and payor accounting platform 115 may be configured to sync to enable payor system 110 to access either payor UI 121 or payor accounting platform 115 to initiate the check generation process. For example, a payor may access payor accounting platform 115 to initiate the check generation process. In response to completing the check generation process, data associated with the check generation process may be generated and stored with both payor accounting platform 115 and check processing system 120. As a further example, a payor may access payor UI 121 to initiate the check generation process. In response to completing the check generation process, data associated with the check generation process may be generated and stored with both payor accounting platform 115 and check processing system 120. The sync may be automatic (e.g., an automatic sync) or may be based on a manual input (e.g., a manual sync).

With reference again to FIG. 1, payee system 130 may be in electronic communication with check processing system 120, payee user interface (UI) 123, and/or financial institution 140. Payee system 130 may be configured to receive check notifications from check processing system 120, interact with check processing system 120 to receive electronic checks, interact with financial institution 140 to deposit or cash the electronic check, and/or the like, as discussed further herein. In various embodiments, payee system 130 may also be configured to receive printed electronic checks from payor system 110. Payee system 130 may comprise any suitable hardware, software, and/or database components capable of transmitting, receiving, and storing data. For example, payee system 130 may comprise one or more servers, computers, laptops, tablets, cellular phones, smartphones (e.g., IPHONE®, BLACKBERRY®, and/or the like), Internet of Things (IoT) devices, and/or the like. Payor system 110 may comprise an operating system, such as, for example, a WINDOWS® mobile operating system, an ANDROID® operating system, APPLE® IOS®, a BLACKBERRY® operating system, a LINUX operating system, and the like. Payee system 130 may also comprise software components configured to allow the payee, via payee system 130, access to payee UI 123. For example, payee system 130 may include a web browser (e.g., MICROSOFT INTERNET EXPLORER®, GOOGLE CHROME®, etc.), an application, a micro-app or mobile application, or the like, configured to allow the payee to access and interact with payee UI 123.

In various embodiments, payee system 130 may be in electronic communication with payee UI 123. Payee UI 123 may comprise software, a mobile application, a web interface, or the like accessible from payee system 130. For example, payee UI 123 may include a graphical user interface (“GUI”), software modules, logic engines, various databases, interfaces to systems and tools, and/or computer networks. Payee UI 123 may allow the payee, via payee system 130, to access, view, and interact with an electronic check, in response to payee system 130 receiving the check notification from check processing system 120. For example, payee system 130 may interact with payee UI 123 to reject the electronic check, print the electronic check, save an image of the electronic check, upload the electronic check directly to financial institution 140, or the like. Payee system 130 may access payee UI 123 via the received check notification, such as, for example, by accessing a hyperlink, entering a URL, or the like. In various embodiments, payee UI 123 may be in electronic and/or operative communication with check processing system 120. In various embodiments, payee UI 123 may be hosted on check processing system 120 (e.g., via a web server, or the like) and accessible via payee system 130.

In various embodiments, financial institution 140 may be in electronic communication with check processing system 120 and/or payee system 130. Financial institution 140 may comprise or interact with a traditional payment network or transaction network, and/or may comprise a regional bank, nationwide bank, or the like capable of issuing and maintaining transaction accounts, such as, for example, checking or savings accounts. Financial institution 140 may be configured to receive checks (e.g., electronic checks, printed electronic checks, physical checks, etc.), process the checks, and update payee transaction accounts based on the processed check. In various embodiments, financial institution 140 may be configured to receive checks electronically or in person (e.g., via a payee visiting a physical location).

In various embodiments, financial institution 140 may comprise any suitable combination of hardware, software, and/or database components, and may include, for example, one or more network environments, servers, web servers, computer-based systems, processors, databases, and/or the like. Financial institution 140 may include systems and databases related to financial and/or transactional systems and processes, such as, for example, one or more authorization engines, authentication engines and databases, settlement engines and databases, accounts receivable systems and databases, accounts payable systems and databases, and/or the like. Financial institution 140 may include one or more processors and/or one or more tangible, non-transitory memories and be capable of implementing logic. The processor may be configured to implement various logical operations in response to execution of instructions, for example, instructions stored on a non-transitory, tangible, computer-readable medium, as discussed further herein.

In various embodiments, check processing system 120 may be in electronic communication with payor system 110 (e.g., via payor UI 121), payee system 130 (e.g., directly or via payee UI 123), and/or financial institution 140. Check processing system 120 may be configured to receive a check generation request, validate the check generation request, and generate an electronic check based on the check generation request, as discussed further herein. In response to generating the electronic check, check processing system 120 may transmit the electronic check to financial institution 140, print a physical copy of the electronic check for mailing or a physical distribution, save the electronic check for batch processing, generate and transmit a check notification to payee system 130, and the like, as discussed further herein.

Check processing system 120 may comprise one or more software, hardware, and/or database components. For example, check processing system 120 may comprise one or more network environments, servers, computer-based systems, processors, databases, and/or the like. Check processing system 120 may also include one or more web servers, data centers, cloud storages, or the like, and may include software, such as APIs, configured to perform various operations discussed herein. In various embodiments, check processing system 120 may comprise at least one computing device in the form of a computer or processor, or a set of computers/processors, although other types of computing units or systems may be used, such as, for example, a distributed computing cluster, a server, web server, pooled servers, or the like. The processor may be a general purpose processor, a digital signal processor (DSP), an application specific integrated circuit (ASIC), a field programmable gate array (FPGA) or other programmable logic device, discrete gate or transistor logic, discrete hardware components, other processing devices, or any combination thereof. Check processing system 120 may include one or more tangible, non-transitory memories capable of implementing logic and instructions. The processor may be configured to implement various logical operations in response to execution of instructions, for example, the instructions stored on a non-transitory, tangible, computer-readable medium, as discussed further herein.

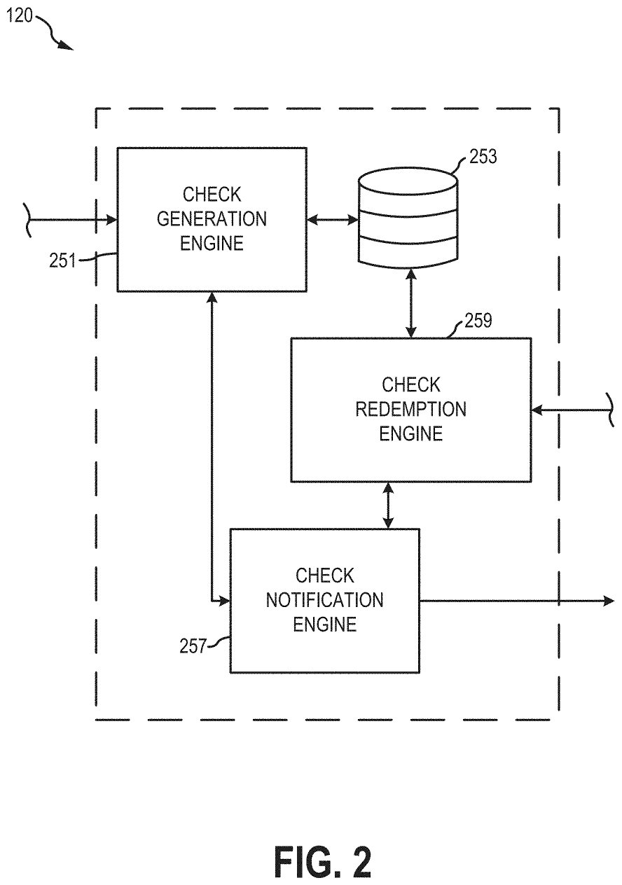

In various embodiments, check processing system 120 may comprise one or more software and/or hardware based components, engines, modules, databases, or the like configured to aid in generating, processing, and transmitting the electronic checks. For example, and with reference to FIG. 2, check processing system 120 may comprise a check generation engine 251, a payor database 253, a check notification engine 257, and/or a check redemption engine 259. Each of check generation engine 251, payor database 253, check notification engine 257, and/or check redemption engine 259 may be in electronic communication with each other via a bus, network, and/or through any other suitable means, or may be individually connected as described further herein.

In various embodiments, check generation engine 251 may be configured to interact with payor system 110, via payor UI 121. For example, check generation engine 251 may be configured to receive a check generation request from payor system 110, process the check generation request, and generate an electronic check based on the check generation request. The check generation request may be based on data from payor database 253. For example, a payor, via payor system 110 and payor UI 121, may access check generation engine 251 and check generation engine 251, via payor UI 121, may display relevant data for the payor to select to generate the check generation request. The check generation request may also be based on direct input from payor system 110. The check generation request may comprise a payor transaction account (e.g., the bank account to withdraw the amount from), a payee name, payee contact information (e.g., company name, address, email address, telephone number, etc.), a check number (e.g., randomly generated, based on the number of previously generated electronic checks, selected by the payor, etc.), a date (e.g., today's date, a future date, etc.), a payment amount (e.g., $150.00), an extended payment amount (e.g., “one hundred fifty dollars”), a memo (e.g., a personalized memo regarding the electronic check), a transmission channel (e.g., physical distribution, batch processing, email, text message, push notification, direct upload to financial institution 140, etc.), and/or any other suitable or desired data. In various embodiments, check generation engine 251 may be in electronic and/or logical communication with payor database 253, and/or check notification engine 257. The generated electronic check may comprise check data such as, for example, the payor transaction account (e.g., routing number and account number), payor information (e.g., payor name, payor address, payor telephone number, etc.), payee contact information, the check number, the date, the payment amount, the extended payment amount, the memo, and/or the like. The electronic check may also comprise an image file (e.g., .BMP, .JPEG, .PNG, .TIFF, .PDF, .DOC, etc.) comprising the check data.

Payor database 253 may be configured to store and maintain payor data. For example, payor database 253 may store and maintain payor login data (e.g., user name, password, biometric input, etc.), payor transaction accounts (e.g., payor checking or savings account numbers and associated financial institution routing numbers), authorized payor users (e.g., name, user name, role, email, etc.), previously generated electronic checks (e.g., the electronic check, an issue date, a check number, payee data, check amount, delivery method, status, etc.), payee data (e.g., payee name, payee company, payee email, payee phone number, payee address, etc.), and/or the like. In various embodiments, payor database 253 may be in electronic and/or logical communication with check generation engine 251 and/or check redemption engine 259.

In various embodiments, check generation engine 251 may also be configured to verify and validate the check generation request. Check generation engine 251 may be configured to validate or verify the check generation request based on internal or external sources. For example, check generation engine 251 may be configured to validate ABA (American Banker's Association) routing numbers to identify the financial institution 140 associated with the check generation request. Check generation engine 251 may be configured to validate the ABA routing number during a registration process, such as, for example, in response to the payor inputting transaction accounts and similar payor data to save in payor database 253 for future use.

In various embodiments, check notification engine 257 may be configured to generate a check notification and transmit the check notification through various transmission channels. The check notification may comprise data notifying the payee that an electronic check has been generated and is available, such as, for example, the payor name, the memo, the payment amount, the payee name, or the like. The transmission channel may specify the channel or means that the payee is to receive the electronic check. For example, the payor may elect to print a physical copy of the electronic check (e.g., a physical distribution) and mail or physically deliver the physical copy to payee system 130. The payor may elect to directly upload the electronic check to financial institution 140 associated with payee system 130. The payor may elect to electronically notify the payee of the electronic check via email, text message, push notification, or the like. The check notification may be an email, text message (e.g., SMS, MMS), push notification, or the like, based on the transmission channel selected by payor system 110. Check notification engine 257 may transmit the check notification to payee system 130. In various embodiments, check notification engine 257 may be in electronic and/or logical communication with check generation engine 251 and/or check redemption engine 259.

In various embodiments, check redemption engine 259 may be configured to enable payees to access, view, and retrieve or redeem electronic checks. For example, in response to receiving the check notification, payee system 130, via payee UI 123, may access check redemption engine 259 to retrieve and/or redeem the electronic check. For example, check redemption engine 259 may receive a check redemption request from payee system 130. The check redemption request may specify how the payee desires to redeem the electronic check, such as, for example, a physical redemption (e.g., payee system 130 prints the electronic check), a direct upload to financial institution 140, an image download (e.g., payee system 130 downloads the electronic check image and transmits the image to financial institution 140), and/or the like. In various embodiments, the check redemption request may comprise a rejection, such as, for example, in response to payee system 130 determining a problem with the electronic check (e.g., incorrect payment amount, misspelling or error, etc.). In various embodiments, check redemption engine 259 may be in electronic and/or logical communication with payor database 253 and/or check notification engine 257.

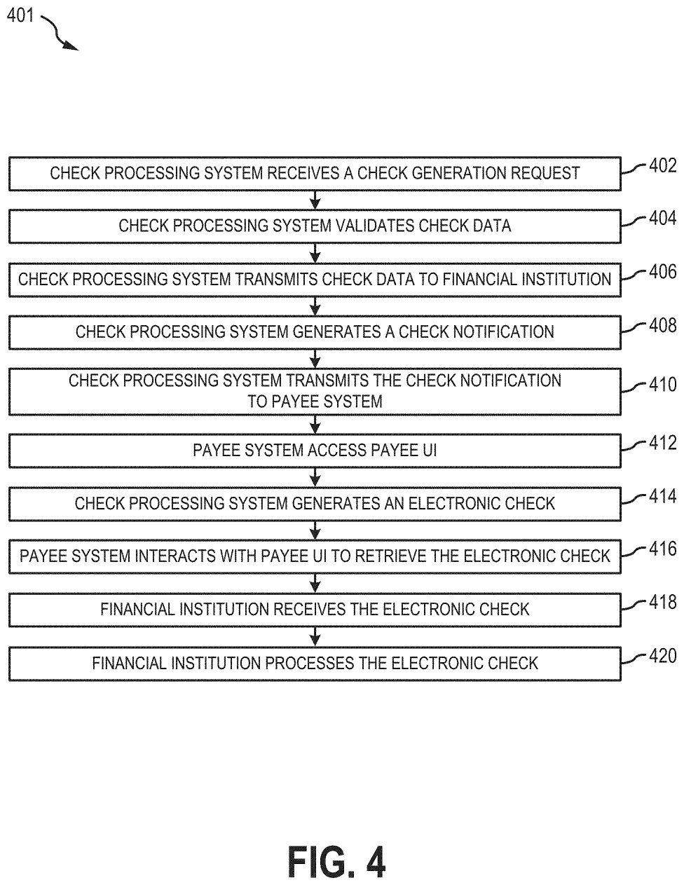

Referring now to FIG. 4 the process flow depicted is merely an embodiment and is not intended to limit the scope of the disclosure. For example, the steps recited in any of the method or process descriptions may be executed in any order and are not limited to the order presented. It will be appreciated that the following description makes appropriate references not only to the steps and elements depicted in FIG. 4, but also to the various system components as described above with reference to FIGS. 1 and 2.

In various embodiments, a method 401 for processing a check generation request is disclosed. Payor system 110 may access check processing system 120, via payor UI 121 to begin method 401. Check processing system 120 may implement any suitable authentication and/or authorization processor to control access to check processing system 120. For example, a payor may access payor UI 121 and submit payor login information (e.g., username, password, biometric input, etc.) to interact with check processing system 120. Check processing system 120 may authenticate the payor login information using any suitable process, such as, for example, by comparing the payor login information against stored login information. As a further example, check processing system 120 may implement a multi-factor authentication, a one-time password, a knowledge-based authentication, or the like to authenticate payor system 110 prior to granting payor system 110 access to check processing system 120. For example, check processing system 120 may generate an authentication challenge and may transmit the authentication challenge to payor system 110. The authentication challenge may comprise a multi-factor authentication challenge. The authentication challenge may comprise a multi-factor authentication challenge. For example, if the payor had previously registered with check processing system 120 using a biometric input, username and password, or the like, the authentication challenge may comprise data prompting the payor to input the biometric input together with the user's password (e.g., a 2-factor authentication). As a further example, a two-factor authentication may comprise sending an authentication number (e.g., a PIN, a code, a 6-digit number, etc.) or phrase to the payor via an established email address or mobile phone number (via SMS), and prompting the payor to input the authentication number or phrase into payor UI 121 before proceeding.

Check processing system 120 receives a check generation request (step 402) from payor system 110, via payor UI 121 (e.g., as depicted in FIG. 3). The check generation request may comprise a payor transaction account (e.g., the bank account to withdraw the amount from), a payee name, payee contact information (e.g., company name, address, email address, telephone number, etc.), a check number (e.g., randomly generated, based on the number of previously generated electronic checks, selected by the payor, etc.), a date (e.g., today's date, a future date, etc.), a payment amount (e.g., $150.00), an extended payment amount (e.g., “one hundred fifty dollars”), a memo (e.g., a personalized memo regarding the electronic check), a transmission channel (e.g., physical distribution, batch processing, email, text message, push notification, direct upload to financial institution 140, etc.), and/or any other suitable or desired data. In various embodiments, the payor may interact with payor UI 121 to input one or more of the data elements in the check generation request. In various embodiments, payor UI 121 may also communicate with payor database 253 to present to the payor previously input data, such as, for example, payor data and payee data, and the payor may select from the previously input data to generate the check generation request.

Check processing system 120 validates the check generation request (step 404). Check processing system 120, via check generation engine 251, may validate and verify data in the check generation request using any suitable technique. For example, check processing system 120, via check generation engine 251, may validate the ABA (American Banker's Association) routing number to identify the financial institution 140 associated with the check generation request. As a further example, check processing system 120, via check generation engine 251, may validate and verify data in the check generation request to ensure that all necessary data that is needed to generate the electronic check has been input.

In various embodiments, check processing system 120 transmits check data to financial institution 140 (step 406). The check data may comprise data corresponding to the check generation request such as, for example, payor transaction account number, check number, payee data, or the like. Financial institution 140 may store and maintain the check data to later validate the electronic check. In that respect, in response to the payee presenting the electronic check to financial institution 140 (e.g., to deposit funds, cash the check, etc.), financial institution 140 may verify that the issued electronic check matches the check data received from check processing system 120. In response to receiving the check data, financial institution 140 may be configured to confirm receipt of the check data with check processing system 120.

In various embodiments, check processing system 120 may be configured to process the check generation request based on the transmission channel specified in the check generation request. The transmission channel may specify the channel or means that the payee is to receive the electronic check. For example, the payor may elect to print a physical copy of the electronic check (e.g., a physical distribution) and mail or physically deliver the physical copy to payee system 130. The payor may elect to directly upload the electronic check to financial institution 140 associated with payee system 130. The payor may elect to electronically notify the payee of the electronic check via email, text message, push notification, or the like (e.g., step 410). In various embodiments, the payor may also elect to batch process a plurality of check generation requests. In that respect, check processing system 120 may process the plurality of check generation requests at a designated time, based on the transmission channel specified in the check generation request.

In various embodiments, check processing system 120 generates a check notification (step 408) in response to the specified transmission channel being an electronic notification. The check notification may comprise data notifying the payee that an electronic check has been generated and is available. For example, the check notification may comprise the payor name, the memo, the payment amount, the payee name, or the like. In that respect, the check notification does not comprise the electronic check, but comprises data sufficient to notify the payee that the electronic check is available. The check notification may also comprise a hyperlink or the like to enable payee system 130 to access payee UI 123 to view the electronic check, as discussed further herein. The check notification may be an email, text message (e.g., SMS, MMS), push notification, or the like, based on the transmission channel selected by payor system 110.

Check processing system 120 transmits the check notification to payee system 130 (step 410). Check processing system 120, via check notification engine 257, may transmit the check notification based on the transmission channel, such as, for example, by email, text message, push notification, or the like.

In response to receiving the check notification, payee system 130 accesses payee UI 123 (step 412), based on the check notification. For example, payee system 130 may interact with the hyperlink (e.g., “View Check”) provided in the check notification to view the electronic check from check processing system 120, via payee UI 123.

In various embodiments, check processing system 120 generates an electronic check (step 414), based on the check generation request. The electronic check may be generated, via check generation engine 251, to comprise check data, such as, for example, the payor transaction account (e.g., routing number and account number), payor information (e.g., payor name, payor address, payor telephone number, etc.), payee contact information, the check number, the date, the payment amount, the extended payment amount, the memo, and/or the like. The electronic check may also comprise an image file (e.g., .BMP, .JPEG, .PNG, .TIFF, .PDF, .DOC, etc.) comprising the check data. In that regard, the electronic check may be generated to mimic a digital representation of a typical physical check. In response to generating the electronic check, check generation engine 251 may store the electronic check (or a copy of the electronic check) in payor database 253.

Payee system 130 interacts with payee UI 123 to retrieve the electronic check (step 416). For example, payee system 130 may interact with check redemption engine 259, via payee UI 123, to transmit a check redemption request to check processing system 120. The check redemption request may specify how the payee desires to redeem the electronic check, such as, for example, a physical redemption (e.g., payee system 130 prints the electronic check), a direct upload to financial institution 140, an image download (e.g., payee system 130 downloads the electronic check image and transmits the image to financial institution 140), and/or the like. In various embodiments, the check redemption request may comprise a rejection, such as, for example, in response to payee system 130 determining a problem with the electronic check (e.g., incorrect payment amount, misspelling or error, etc.).

In various embodiments, financial institution 140 receives the electronic check (step 418). Financial institution 140 may receive the electronic check from check processing system 120 or payee system 130. For example, financial institution 140 may receive the electronic check from check processing system 120 in response to payee system 130 selecting to upload the electronic check directly to financial institution 140 (e.g., step 416). As a further example, financial institution 140 may receive the electronic check from payee system 130 in response to an electronic submission (e.g., payee system 130 transmits the electronic check to financial institution 140, such as through a mobile application) or physical submission (e.g., payee system 130 physically provides the printed electronic check to financial institution 140).

Financial institution 140 processes the electronic check (step 420). Financial institution 140 may process the electronic check using any suitable method. For example, financial institution 140 may verify and validate the electronic check based on the check data (e.g., received in step 406). In response to the check data matching the electronic check, financial institution 140 may deposit the funds into the payee's transaction account. In that regard, funds may be available in real time (or near real time) as soon as the payee deposits the electronic check. In various embodiments, payor system 110 may reconcile the electronic check similar to typical physical check reconciliation. In various embodiments, the system may sync with payor accounting platform 115 to reconcile the electronic check. Payor system 110 may sync with payout accounting platform 115, and/or payout accounting platform 115 may sync with payor system 110.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “transmit” may include sending at least a portion of the electronic data from one system component to another (e.g., over a network connection). Additionally, as used herein, “data,” “information,” or the like may include encompassing information such as commands, queries, files, messages, data for storage, and the like in digital or any other form.

As used herein, “electronic communication” may comprise a physical coupling and/or non-physical coupling capable of enabling system components to transmit and receive data. For example, “electronic communication” may refer to a wired or wireless protocol such as a CAN bus protocol, an Ethernet physical layer protocol (e.g., those using 10BASE-T, 100BASE-T, 1000BASE-T, etc.), an IEEE 1394 interface (e.g., FireWire), Integrated Services for Digital Network (ISDN), a digital subscriber line (DSL), an 802.11a/b/g/n/ac signal (e.g., Wi-Fi), a wireless communications protocol using short wavelength UHF radio waves and defined at least in part by IEEE 802.15.1 (e.g., the BLUETOOTH® protocol maintained by Bluetooth Special Interest Group), a wireless communications protocol defined at least in part by IEEE 802.15.4 (e.g., the ZIGBEE® protocol maintained by the ZigBee alliance), a cellular protocol, an infrared protocol, an optical protocol, or any other protocol capable of transmitting information via a wired or wireless connection.

One or more of the system components may be in electronic communication via a network. As used herein, the term “network” may further include any cloud, cloud computing system, or electronic communications system or method that incorporates hardware and/or software components. Communication amongst the nodes may be accomplished through any suitable communication channels such as, for example, a telephone network, an extranet, an intranet, Internet, point of interaction device (personal digital assistant, cellular phone, kiosk, tablet, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using Internetwork Packet Exchange (IPX), APPLETALK® program, IP-6, NetBIOS, OSI, any tunneling protocol (e.g. IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the Internet is generally known to those skilled in the art and, as such, need not be detailed herein.

The various system components may be independently, separately or collectively suitably coupled to the network via data links which includes, for example, a connection to an Internet Service Provider (ISP) over the local loop as is typically used in connection with standard modem communication, cable modem, DISH NETWORKS®, ISDN, DSL, or various wireless communication methods.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PKI, GPG (GnuPG), HPE Format-Preserving Encryption (FPE), Voltage, Triple DES, Blowfish, AES, MD5, HMAC, IDEA, RC6, and symmetric and asymmetric cryptosystems. Network communications may also incorporate SHA series cryptographic methods, elliptic-curve cryptography (e.g., ECC, ECDH, ECDSA, etc.), and/or other post-quantum cryptography algorithms under development.

For the sake of brevity, conventional data networking, application development, and other functional aspects of the system may not be described in detail herein. Furthermore, the connecting lines shown in the various figures contained herein are intended to represent exemplary functional relationships and/or electronic communications between the various elements. It should be noted that many alternative or additional functional relationships or electronic communications may be present in a practical system.

In various embodiments, the methods described herein are implemented using the various particular machines described herein. The methods may be implemented using the particular machines described herein, and those hereinafter developed, in any suitable combination, as would be appreciated immediately by one skilled in the art. Further, as is unambiguous from this disclosure, the methods described herein may result in various transformations of certain articles.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by artificial intelligence (AI) or machine learning. Artificial intelligence may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

In fact, and in accordance with various embodiments, the embodiments are directed toward one or more computer systems capable of carrying out the functionality described herein. The computer system includes one or more processors. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

The computer system also includes a main memory, such as for example random access memory (RAM), and may also include a secondary memory or in-memory (non-spinning) hard drives. The secondary memory may include, for example, a hard disk drive and/or a removable storage drive. The removable storage drive reads from and/or writes to a removable storage unit in a well-known manner. As will be appreciated, the removable storage unit includes a computer usable storage medium having stored therein computer software and/or data. The secondary memory may include other similar devices for allowing computer programs or other instructions to be loaded into the computer system. Such devices may include, for example, a removable storage unit and an interface, which allow software and data to be transferred from the removable storage unit to computer system.

The computer system may also include a communications interface configured to allow software and data to be transferred between the computer system and external devices, systems, or networks. Examples of a communications interface may include a modem, a network interface (such as an Ethernet card), a communications port, etc. Software and data files transferred via the communications interface are in the form of signals which may be electronic, electromagnetic, optical, or other signals capable of being received by a second communications interface. These signals are provided to the communications interface via a communications channel, and may be implemented using wire, cable, fiber optics, a telephone line, a cellular link, a radio frequency (RF) link, wireless and other communications channels.

Computer programs (also referred to as computer control logic) may be stored in the main memory and/or the secondary memory. Computer programs may also be received via the communications interface. Such computer programs, when executed, enable the computer system to perform the features as discussed herein. In particular, the computer programs, when executed, enable the processor to perform the features of various embodiments. Accordingly, such computer programs may represent controllers of the computer system. Software may be stored in a computer program product and loaded into computer system using removable storage drive, hard disk drive or communications interface. The control logic (software), when executed by the processor, causes the processor to perform the functions of various embodiments as described herein.

Any databases discussed herein may include relational, hierarchical, graphical, blockchain, object-oriented structure, and/or any other database configurations. In various embodiments, any database may also include a no-SQL database, a key-value database, an in-memory database, a GPU database, and/or the like. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, N.Y.), various database products available from ORACLE® Corporation (Redwood Shores, Calif.), MICROSOFT ACCESS® or MICROSOFT SQL SERVER® by MICROSOFT® Corporation (Redmond, Wash.), MYSQL® by MySQL AB (Uppsala, Sweden), MONGODB®, Redis, Apache Cassandra®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Any of the communications, inputs, storage, databases, or displays discussed herein may be facilitated through a website having web pages. The term “web page” or “website” as used herein is not meant to limit the type of documents and applications that might be used to interact with the user (e.g., via payor UI 121 or payee UI 123). For example, a typical website might include, in addition to standard HTML documents, various forms, JAVA® applets, JAVASCRIPT®, active server pages (ASP), common gateway interface scripts (CGI), extensible markup language (XML), dynamic HTML, cascading style sheets (CSS), AJAX (Asynchronous JAVASCRIPT® And XML), helper applications, plug-ins, and the like. A web server may include a web service that receives a request from a web server, the request including a URL and an IP address (e.g., 10.0.0.2). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. For example, representational state transfer (REST), or RESTful, web services may provide one way of enabling interoperability between applications.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, JAVASCRIPT Object Notation (JSON), VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript, or the like. Cryptography and network security methods are well known in the art, and are covered in many standard texts.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, BLU-RAY, optical storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks. Accordingly, functional blocks of the block diagrams and flowchart illustrations support combinations of means for performing the specified functions, combinations of steps for performing the specified functions, and program instruction means for performing the specified functions.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosures.

The scope of the disclosures is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system for securely transmitting an electronic check, comprising:
a processor; and
a tangible, non-transitory memory configured to communicate with the processor, the tangible, non-transitory memory having instructions stored thereon that, in response to execution by the processor, cause a check processing system to perform operations comprising:
receiving, by the check processing system in electronic communication with a payor system, a check generation request;
transmitting, by the check processing system in electronic communication with a payee system, a payee check notification, wherein in response to receiving the payee check notification the payee system is configured to interact with the check processing system;
generating, by the check processing system, the electronic check based on the check generation request; and
receiving, by the check processing system from the payee system, a check redemption request comprising a physical redemption selection, an electronic redemption selection, or a check rejection.

2. The system of claim 1, wherein the check generation request comprises at least one of payor data, payee data, a check number, a date, a payment amount, an extended payment amount, a memo, or a transmission channel.

3. The system of claim 2, wherein the transmission channel comprises a physical distribution, batch processing, an email, a text message, a push notification, or a direct upload to a financial institution.

4. The system of claim 2, wherein the payee check notification is transmitted based on the transmission channel specified in the check generation request.

5. The system of claim 2, wherein the payee check notification comprises at least one of payor data, payee data, the payment amount, and an access hyperlink, wherein the check notification does not comprise the electronic check.

6. The system of claim 5, wherein the payee system is configured to interact with the check processing system by accessing the access hyperlink.

7. The system of claim 1, further comprising transmitting, by the check processing system, check data to a financial institution, wherein the check data corresponds to the check generation request.

8. The system of claim 7, wherein the financial institution is configured to process the electronic check by comparing the check data to the electronic check.

9. A method comprising:
receiving, by a processor, a check generation request;
transmitting, by the processor, a payee check notification to a payee system;
generating, by the processor, an electronic check based on the check generation request;
receiving, by the processor and from the payee system, a check redemption request comprising a physical redemption selection, an electronic redemption selection, or a check rejection; and
syncing, by the processor, at least one of the check generation request or the electronic check with a payor accounting platform.

10. The method of claim 9, wherein the payor accounting platform comprises Intuit QuickBooks.

11. The method of claim 9, wherein the check generation request comprises at least one of payor data, payee data, a check number, a date, a payment amount, an extended payment amount, a memo, or a transmission channel.

12. The method of claim 11, wherein the transmission channel comprises a physical distribution, batch processing, an email, a text message, a push notification, or a direct upload to a financial institution.

13. The method of claim 11, wherein the payee check notification is transmitted based on the transmission channel specified in the check generation request.

14. The method of claim 11, wherein the payee check notification comprises at least one of payor data, payee data, the payment amount, and an access hyperlink, wherein the check notification does not comprise the electronic check.

15. The method of claim 14, wherein the payee system is configured to interact with the check processing system by accessing the access hyperlink.

16. A check processing system comprising:
a processor; and
a tangible, non-transitory memory configured to communicate with the processor, the tangible, non-transitory memory having instructions stored thereon that, in response to execution by the processor, cause the processor to perform operations comprising:
receiving, by the processor and from a payor system, a check generation request;
transmitting, by the processor and to a payee system, a payee check notification;
generating, by the check processing system, an electronic check based on the check generation request;
receiving, by the check processing system and from the payee system, a check redemption request comprising a physical redemption selection, an electronic redemption selection, or a check rejection; and
transmitting, by the check processing system, check data to a financial institution, wherein the check data corresponds to the check generation request.

17. The system of claim 16, further comprising authenticating, by the check processing system, the payor system.

18. The system of claim 17, wherein the authenticating comprises:
receiving, by the check processing system and from the payor system, a user credential; and
validating, by the check processing system, the user credential.

19. The system of claim 17, wherein the authenticating comprises:
transmitting, by the check processing system, an authentication challenge; and
receiving, by the check processing system and from the payor system, an authentication response based on the authentication challenge.

20. The system of claim 16, wherein the payor system is configured to interface with a payor accounting platform to record at least one of the check generation request or the electronic check.
